(19) United States
(12) Patent Application Publication
(10) Pub. No.: US 2010/0290332 A1
(43) Pub. Date: Nov. 18, 2010

(54) OPTICAL DATA CARRIER WITH REFERENCE LAYER

(75) Inventors: Andrew Shipway, Jerusalem (IL); Kozo Nakao, Tokorozawa-city (JP); Ilya Rubinovich, Rehovot (IL); Yoshihiro Takatani, Chikusei-city (JP); Ariel Litwak, Ramat Hasharon (IL); Adam Paul Olsen, Media, PA (US); Mark Anthony Aubart, West Chester, PA (US); Robert Adam Wabat, Langhorne, PA (US); Ryan Richard Dirkx, Glenmoore, PA (US); Harold Reid Banyay, Bensalem, PA (US)

Correspondence Address: OLIFF & BERRIDGE, PLC, P.O. BOX 320850, ALEXANDRIA, VA, 22320-4850, US

(73) Assignee: MEMPILE INC., WILMINGTON, DE (US)

(21) Appl. No.: 12/598,716

(22) PCT Filed: May 7, 2008
(86) PCT No.: PCT/IL08/00629

§ 371 Date: Jun. 24, 2010

Related U.S. Application Data
(60) Provisional application No. 60/916,917, filed on May 9, 2007.
(60) Provisional application No. 60/943,116, filed on Jun. 11, 2007.

(51) Int. Cl. G11B 3/70

(52) U.S. Cl. 369/284; G9B/3.103

(57) ABSTRACT

An optical information carrier is presented. The information carrier comprises at least one active layer for recording/reading data in/from as a result of one- or multi-photon interaction; and at least one reference layer structure associated with said at least one active layer. The reference layer structure comprises at least one dielectric material and is different from that of the active layer in its optical properties with respect to one- or multi-photon interaction. Detection of light returned from the reference layer structure allows to control a process of focusing an optical beam onto an addressed recording plane in the active layer during at least one of the recording and reading processes.

### FIELD OF THE INVENTION

The present invention is generally in the field of optical data carriers and relates to a data carrier utilizing one or more reference layers utilized in recording information on a plurality of recording planes in a recording layer.

### BACKGROUND OF THE INVENTION

Current approaches for optical data storage are based primarily on reflective media. Accordingly, commercially available optical data carriers have one or two data layers, where in the latter case the two layers are separated by a distance of about 50 microns.

In the field of optical recording media, various techniques have been developed to increase recording density, including providing fine-patterned pit length and track pitch, shortening the laser wavelength, and using increased numerical aperture (NA) of the objective lens. In recent years, for the purpose of achieving a further increase in the recorded data density, three dimensional recording media have been proposed that include multi-layered recording planes.

Multi-layer data recording in such a three dimensional optical data carrier requires precise control of a focused recording/reading beam to a desired position in the thickness direction of the medium, or the focus direction. For example, U.S. Pat. Nos. 5,408,453, 6,538,978 and 6,738,322 disclose an optical information storage system having a multi-recording-plane record carrier and a scanner device for the carrier. In addition to the recording/reading beam, a reference beam is projected coaxially with the recording/reading beam. The reference beam is focused on a reference track in the carrier by tracking and focusing servo.

Another recently developed technique for a multi-layer recording scheme employs a data carrier having a fluorescent property variable on occurrence of single- or multi-photon absorption (see for example WO 2004/032134 assigned to the assignee of the present application). In this scheme, data layers (substantially parallel to the disk surface) are not physically formed in advance, but rather are recorded in an isotropic medium in the form of a three-dimensional pattern of data voxels.

### GENERAL DESCRIPTION

There is a need in the art for a novel optical information carrier and data recording/reading process therein enabling to significantly increase the density of recordable and readable information.

The present invention utilizes an optical information carrier formed with at least one reference layer structure interfacing with at least one recording or active layer. Each recording layer (plate) is configured to accommodate multiple recording planes. The recording layer includes an active material that changes its optical property as a result of one- or multi-photon interaction during a recording process, so as to be excitable to emit a response light during a reading process. The reference layer structure includes dielectric material(s) and is different from the active layer in its optical properties with respect to the one- or multi-photon interaction. By detecting light interaction with the reference layer, a process of focusing an optical beam onto the addressed recording plane can be controlled during at least one of the recording and reading processes.

Generally, the reference layer structure may be located below the recording layer(s), i.e., it may be the lowermost layer in the information carrier in a direction of incident light propagation towards the carrier. As the reference layer structure exhibits different optical properties with respect to one- or multi-photon interaction as compared to the recording layer, an interface between the recording and reference layers can be identified by a change in the optical response to a reading beam, thus enabling stable focal positioning of the recording/reading beam on the addressed recording plane.

In the above embodiment, the reference layer structure may or may not be reflective to some reference light, as well as may or may not be transmitting for recording/reading light beams and emitted response of the active layer. Preferably, however, the present invention utilizes the reference layer structure, which is at least partially reflective for a reference beam wavelength (which may be the same or different from the recording and reading beam wavelengths which may also be the same or different from each other). In embodiments of the invention in which the reference layer structure is located in between two active layers, the reference layer structure is to be substantially optically transparent for the optical beam used in the recording and reading processes and for the emitted response light. In this construction, it should be understood that a requirement for the reference layer structure to be “substantially transparent” with respect to the recording/reading/response light signifies that optical losses of the reference layer structure for the recording/reading/response light is sufficiently small. The losses in this respect are caused by reflectivity and absorption; keeping in mind that the absorption coefficient of the reference layer is very small (practically negligible) as will be described below, the losses for the recording/reading/response light are mainly associated with the reflectivity of the reference layer structure for this spectrum. The reference layer structure is thus configured to have reflectivity for recording/reading/response light less than 30%, and preferably substantially not exceeding 0.1%. While the requirement for the reference layer structure to be “at least partially reflective” with respect to a reference beam signifies that the reference layer structure provides a minimal required reflection response to the reference beam enabling the tracking (as will be described below). Preferably, the partially reflective reference layer structure is configured to define a plurality of interfaces at different distances from the active layer. It should be understood that the optical property of the reference layer structure with respect to the reference beam and the recording/reading beams is defined by the effect of these interfaces on light propagation through the reference layer structure.

The above configuration is typically achieved by fabricating the reference layer structure such that it exhibits an internal surface relief pattern. The pattern is typically in the form of spaced-apart pits, which results in three or four interfaces.

The pits are preferably arranged in a spaced-apart relationship along an array of spaced-apart tracks, which may be segments of a continuous spiral path or concentric rings. The pits may be arranged in a spaced-apart relationship within grooves provided in the spaced-apart tracks.

According to some embodiments of the invention, one or more parameters of the surface-relief pattern is/are selected so as to track scanning of the recording planes in the active layer during the recording and/or reading process. The parameters of the pattern are preferably selected to enhance reflective response of the reference layer structure to the reference beam. These parameters include: a distance between the tracks, and/or a degree of overlap between the pits on adjacent tracks along at least one of tangential and radial directions, and/or the pit dimension. Preferably, the pits are arranged with no overlap between them in the radial direction.

The information carrier may also include a support layer, e.g. interfacing the reference layer structure at its side opposite to that interfacing with the active layer. The reference layer structure may, for example, be implemented by an appropriate reflective coating on a patterned (e.g. by stamper) surface of the support layer.

The reference layer structure may include a first dielectric layer coated with a second dielectric film. The desired reflectivity of the reference layer structure may be tuned by adjusting the thickness of the film.

The reference layer structure may have a refractive index different from the refractive index of the active layer. The refractive index difference is such that the desired partial reflectivity is created at an interface between the active layer and the reference layer structure.

Preferably, the reference layer structure has a certain topography (relief pattern and thickness) and chemical composition selected in accordance with the refractive indices of the recording and reference layers' materials used and in accordance with recording, reading, response signal, and reference wavelengths, to enable effective recording and reading processes.

The optical information carrier utilizes a 3-D optical data storage medium, namely the medium in which data can be recorded in the form of spaced-apart recorded regions arranged in a 3-D pattern within multiple recording planes. The information carrier may be a disk with a diameter of 120 millimeters and a preferred thickness of 1.2 millimeters to be consistent with existing CD and DVD form factors. Multiple layers (plates) of lesser thicknesses are laminated or otherwise adhered together, to form the final thickness. Ideally, the disk may be extremely flat and of uniform thickness.

The data storage medium or recording medium contains a recordable active material. By “active”, or “recording”, material as used herein is meant a material capable of storing data in the form of a three dimensional pattern by irradiation, and which can later be read to retrieve said data.

In one embodiment, the active layer contains a chromophore that can exist in more than one isomeric form. The chromophore is dispersed in a polymer matrix, enabling the mechanical and chemical properties to be tuned for optimum performance. To eliminate volatility of written data, the chromophore may be chemically bound to the polymer matrix, for example, by functionalizing the chromophore with a chemical group that can be copolymerized. In a preferred embodiment, the chromophore and its comonomers are acrylics. A most preferred embodiment being an arylalkylene chromophore copolymerized with methylmethacrylate and optionally comonomers.

By “reference layer structure” as used herein is meant a patterned layer structure partially reflective with respect to a predetermined wavelength range (reference beam) and substantially transmitting with respect to another predetermined wavelength range (recording and reading beams). A reference layer structure may comprise several sub-layers and interfaces, internal between the sub-layers and with the adjacent layers. The reference layer structure is patterned to enable, when interrogated by a focused laser beam, a reference frame for controlling the depth and horizontal position of a recording beam within a disk without physically defined recording planes. A single reference layer structure may provide both depth and horizontal position. In one embodiment, the reference layer structure contains a spiral track of topographical features that modulate reflectivity. This layer structure can be monitored by a focused reference beam of one wavelength while data is written or read by a coaxial laser beam of another wavelength focused at a different depth within the disk.

The storage medium may also include one or more support layers. By “support layer” as used herein is meant a non-active layer to which the other layers may be laminated for improved disk rigidity or toughness. A support layer is typically a polymer layer. One or more support layers may be needed if, for example, the active material is a polymer with low Tg or a polymer with otherwise insufficient mechanical integrity. The support polymer is generally a transparent thermoplastic. Some transparent thermoplastics useful in the invention include, but are not limited to: acrylonitrile/styrene/acrylate, polycarbonate, polyester, polyethylene terephthalate glycol, acrylonitrile/acrylate copolymer, polystyrene, styrene/acrylonitrile copolymer, methyl methacrylate/styrene copolymer, acrylonitrile/methyl methacrylate copolymer, acrylonitrile/methyl methacrylate/styrene butadiene multi-polymer, polyolefins, imidized acrylic polymer, or an acrylic polymer. In a preferred embodiment, the transparent thermoplastic is a poly(meth)acrylate homopolymer or copolymer, or polycarbonate.

By “acrylic” as used herein is meant copolymer(s) having 30 percent or more of acrylic and/or methacrylic monomer units. “Copolymer”, as used herein, refers to a polymer having two or more different monomer units (including terpolymers and those with three or more different monomers). The copolymer may have any type of polymer architecture, including random, block, graft, and tapered polymers, as well as combs, stars and other architectures. “(Meth)acrylate”, or (meth)acrylic is used herein to include both the acrylate, methacrylate or a mixture of both the acrylate and methacrylate. Useful acrylic monomers include, but are not limited to, methyl (meth)acrylate, ethyl(meth)acrylate, n-propyl(meth)acrylate, isopropyl(meth)acrylate, n-butyl(meth)acrylate, isobutyl(meth)acrylate, sec-butyl(meth)acrylate, tert-butyl (meth)acrylate, amyl(meth)acrylate, isoamyl(meth)acrylate, n-hexyl(meth)acrylate, cyclohexyl(meth)acrylate, 2-ethylhexyl(meth)acrylate, pentadecyl(meth)acrylate, dodecyl(meth)acrylate, isobornyl(meth)acrylate, phenyl(meth)acrylate, benzyl (meth)acrylate, phenoxyethyl(meth)acrylate, 2-hydroxyethyl(meth)acrylate and 2-methoxyethyl(meth)acrylate. Also included are acrylic acid and methacrylic acid and salts thereof. Preferred acrylic monomers include methyl acrylate, ethyl acrylate, butyl acrylate, and 2-ethyl-hexyl-acrylate, methyl methacrylate, ethyl methacrylate, and butyl methacrylate. The chromophores of the invention can also be synthesized onto acrylate or methacrylate monomers.

In addition to the acrylic monomer units, the acrylic copolymer of the invention can also include up to 70 percent of other ethylenically unsaturated monomers polymerizable with the acrylic monomers, including, but not limited to styrene, alpha-methyl styrene, butadiene, vinyl acetate, vinylidene fluorides, vinylidene chlorides, acrylonitrile, alkyl and aryl maleimides, vinyl sulfone, vinyl sulfides, and vinyl sulfoxides.

Both the active and non-active layers may contain additives to improve performance, including impact modifiers, UV stabilizers, optical enhancers including those described in U.S. patent application Ser. No. 10/951,849 incorporated herein by reference, plasticizers, surfactants, fillers, stabilizers, lubricants, colorants, pigments, and antioxidants. Also, active monomers, such as diarylalkene derivatives, are envisioned.

According to one broad aspect of the invention, there is provided an optical information carrier comprising:

at least one active layer for recording/reading data in/from as a result of one- or multi-photon interaction; and

at least one reference layer structure associated with said at least one active layer, the reference layer structure comprising at least one dielectric material and being different from that of the active layer in its optical properties with respect to one- or multi-photon interaction, detection of light returned from the reference layer structure allowing to control a process of focusing an optical beam onto an addressed recording plane in the active layer during at least one of the recording and reading processes.

According to another broad aspect of the invention, there is provided an optical information carrier, comprising:

at least one active layer for recording/reading data therein as a result of one- or multi-photon interaction; and

at least one reference layer structure interfacing with the active layer, the reference layer being at least partially reflective for a reference beam wavelength range, an interface between the active layer and the reference layer structure having a pattern of spaced-apart pits arranged in multiple tracks structure, an arrangement of said pits in the interface plane being selected to enable controlling at least one of the reading and recording processes by detecting reflection of the reference beam from said interface.

In yet a further aspect of the invention, there is provided an optical information carrier, comprising:

at least one active layer for recording/reading data therein as a result of one- or multi-photon interaction; and

at least one reference layer structure associated with said at least one active layer, the reference layer structure carrying spatial-positional information, said reference layer structure comprising at least one dielectric material layer having different optical properties with respect to one- or multi-photon interaction used in the recording and reading processes as compared to its adjacent layer at one or both sides thereof, said reference layer structure defining a patterned surface interfacing with the adjacent layer, the reference layer structure being configured to be substantially optically transparent for the recording and reading light and for light response of the active layer during the reading process and to be at least partially reflective for a reference beam, to thereby enable, by said patterned surface, control of the reference beam scanning of a reference track in the reference layer structure by detecting reflections of the reference beam from the reference layer structure, thereby controlling coupled optical beam scan in the active layer.

According to yet another broad aspect of the invention, there is provided an optical information carrier comprising:

at least one active layer for recording/reading data in/from as a result of one- or multi-photon interaction; and at least one reference layer structure associated with said at least one active layer,

the reference layer structure comprising a dielectric material and having optical properties with respect to one- or multi-photon interaction different from that of the active layer, the reference layer structure being configured to have at least two of the following features:

a) it is substantially transparent to light used in recording and reading processes;

b) it is at least partially reflective to a reference beam wavelength range;

c) it is substantially transparent to light response of the active layer as a result from said interaction;

d) it has a pattern comprising tracking information detectable by at least one optical beam.

### BRIEF DESCRIPTION OF THE DRAWINGS

In order to understand the invention and to see how it may be carried out in practice, embodiments will now be described, by way of non-limiting examples only, with reference to the accompanying drawings, in which:

FIGS. 1A to 1D illustrate cross-sectional views (circumferential direction) of an optical information carrier of the invention according to four examples, respectively;

FIGS. 2A and 2B show two examples of the reference layer structure suitable for use in the information carriers of the examples of FIGS. 1A-1D;

FIGS. 3A to 3D illustrate four examples of optical diagram around the optical data carriers;

FIG. 4 is a table summarizing measured properties of optical carriers in examples 4-10 described below;

FIG. 5 illustrates a section of a reference layer pattern in which pits are periodically arranged in a spiral track;

FIG. 6 shows power distribution of the reflected reference beam as a function of different positions of the reference beam relative to the center of a track for the structure shown in FIG. 1C;

FIGS. 7 to 11 illustrate the signal and tracking signals for various structure and wavelength conditions, and

FIG. 12 exemplifies an optical system for recording/reading data in the optical data carrier of the present invention.

### DETAILED DESCRIPTION OF EXEMPLARY EMBODIMENTS

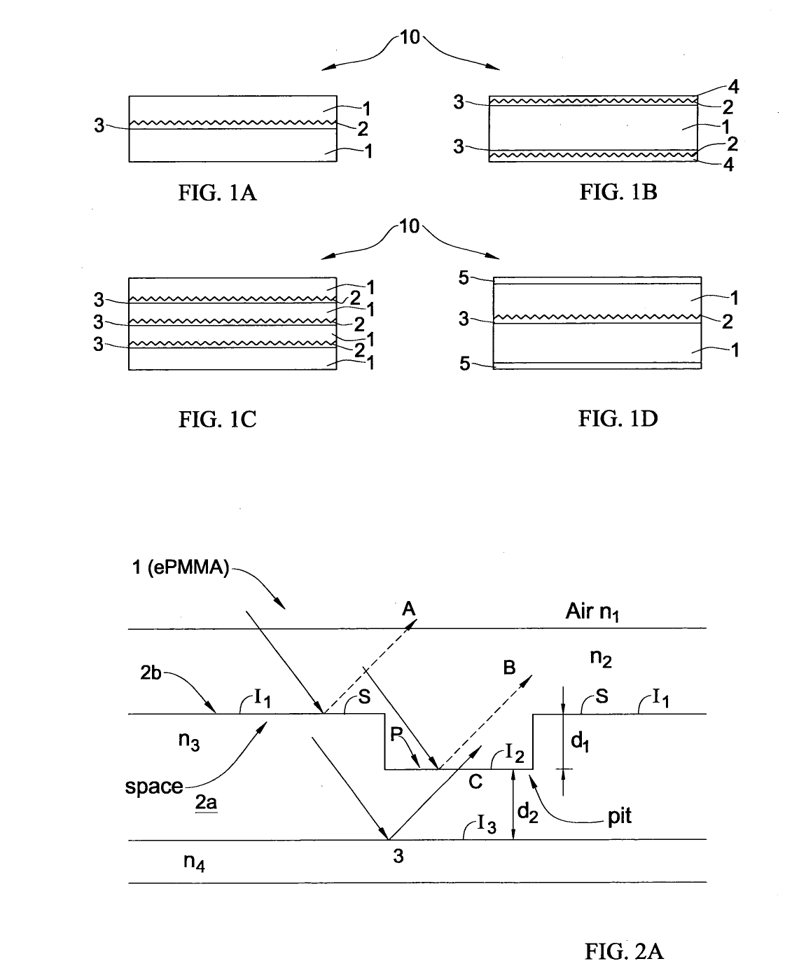

Referring to FIGS. 1A-1D, there are shown four examples of an optical data carrier, generally designated 10. In order to facilitate understanding, the same reference numbers are used for identifying common components in all the examples. Generally, the data carrier 10 according to the present invention includes at least one recording layer 1, and at least one reference layer structure 2.

In the optical data carrier exemplified in FIG. 1A, two recording layers 1 are associated with one reference layer structure 2 between them.

In the example of FIG. 1B, one recording layer 1 is associated with two reference layer structures 2 interfacing with the recording layer 1 at opposite sides thereof and substrate (support) layers 4 are adjacent to the reference layers (top and bottom).

FIG. 1C shows the optical data carrier 10 including four recording layers 1 spaced from each other by three respective reference layer structures 2.

FIG. 1D shows the optical data carrier 10 including two recording layers 1, one reference layer structure 2 between them, and two protective (support) layers 5 at the outer sides of the recording layers.

It should be noted, although not specifically shown in each case, that in the examples of FIG. 1A, FIG. 1B and FIG. 1C, the data carrier is preferably also formed with protective (support) layers at its outer surfaces. This can be implemented by applying suitable transparent substrates or depositing films over the upper surface of the uppermost recording layer and the lower surface of the lowermost recording layer. The protective layers can be formed within the same storage medium by locating the uppermost and lowermost recording layers at a certain distance (depth) from the respective upper and lower surfaces of the medium, where this depth is selected so as to provide attenuation of ambient light passing through to a level in which it will not cause any harmful interaction. This technique is disclosed in U.S. Provisional 60/872,512, assigned to the same assignee.

The recording layer 1 is composed of recording media, in which a data pattern can be recorded and read by optical interaction.

Such a recording media may be similar to those disclosed in various patent applications and patents assigned to the assignee of the present application. For example, WO 01/73779 discloses a non-linear three-dimensional memory for storing information in a volume comprising an active medium. The active medium is capable of changing from a first to a second isomeric form as a response to radiation of a light beam having energy substantially equal to first threshold energy. The concentration ratio between a first and a second isomeric form in any given volume portion represents a data unit. This publication discloses an optical storage medium that comprises diarylalkene derivatives, triene derivatives, polyene derivatives or a mixture thereof. An optical storage medium with photoactive groups has been disclosed in various other publications assigned to the assignee of the present application, for example WO 2006/0117791, WO 2006/075326, WO 2001/073779, WO 2006/075328, WO 2003/070689, WO 2006/111973, WO 2006/075327 and WO 2006/075329.

The recording layer material is of the kind whose optical property is changeable by one- or multi-photon absorption of certain wavelength(s). The latter is used for recording. In some embodiments of the invention, the optical recording media in its non-recorded form has a fluorescent property and the intensity of fluorescence is decreased as a result of recording. In some other embodiments, the recording media in its non-recorded state has no or weak fluorescence and in the recorded form has stronger fluorescence. In alternative embodiments, data may be detected by other chi(2) or higher processes such as Raman scattering or various four wave mixing techniques. Some of the recording materials are generally referred to as ePMMA.

The recording layer 1 has a certain thickness that defines the number of recording planes to be formed in the information carrier. The number of recording planes that can be formed in the recording layer is determined inter alia by the non-linear media response signal, the optics (e.g. interrogation wavelength and/or numerical aperture), the accuracy of the recording/reading optical system and the dimensional precision of the data carrier itself. The recording layer 1 itself is a bulk substrate, isotropic with respect to the wavelength resolution (as discussed in WO 06/075327 assigned to the assignee of the present application). Such a bulk substrate may be composed of a single material having a fluorescent property variable on occurrence of one- or multi-photon absorption, and may be a substrate material in which another material having a fluorescent property variable on occurrence of one- or multi-photon absorption is uniformly dissolved or embedded, substantially uniformly dispersed, or aggregated in uniformly dispersed clusters that are significantly finer than the integrating source resolution.

The recording layer may or may not contain dedicated positional information in either the recording plane (radial/tracking direction) or the data carrier thickness direction (focus direction). Positional information may be derived from the reference layer structure 2, as will be described further below, such that data can be recorded with the aid of the tracking direction position signal in the reference layer structure 2 and the data for setting the focus direction distance from the reference layer structure 2 to the recording layer.

The reference layer structure 2 is used for guiding the focus point of a reference beam that serves for determining the position of the focus point of a recording/reading beam and possibly also for other auxiliary purposes, such as providing general disk information (manufacturer, batch number, etc.).

According to the invention, the reference layer structure 2 is a single- or multi-layer structure configured to optimize light propagation through the recording medium during the recording and reading processes, for a given recording layer structure (refractive index, topography, and thickness). The optimized light propagation scheme is such as to enable focus control of recording and reading beams onto desired planes and to enable detectable response during reading.

As shown in FIGS. 1A-1D, the reference layer structure(s) is/are disposed substantially parallel to the carrier surfaces and recording layer(s) surfaces, and interface the recording layer(s) being placed above and/or below the recording layer(s).

As mentioned above and will be described more specifically further below, the reference layer structure is configured to define at least three interfaces for an optical beam propagation at different depths in the storage medium. These interfaces are boundaries between materials of different optical properties in different positioning. The interfaces may be created by an embossed pattern, which provides at least two responses (reflections) to the optical reference beam and is configured to enable tracking of the optical reference beam based on reflections of the optical reference beam from this pattern. Such a pattern in the internal surface of the reference layer structure may comprise a plurality of discrete pits, or a plurality of concentric circular grooves, or spiral (and slightly wobbled) grooves, or a combination of the above, namely groove(s) with discrete pits therein.

The patterned interface (i.e., having a surface relief) may be configured to enable detection of the location of a reference layer structure based on a change in fluorescence of the read (response) beam from this surface and the surrounding layers, and the position on the surface may be found by use of the pattern response.

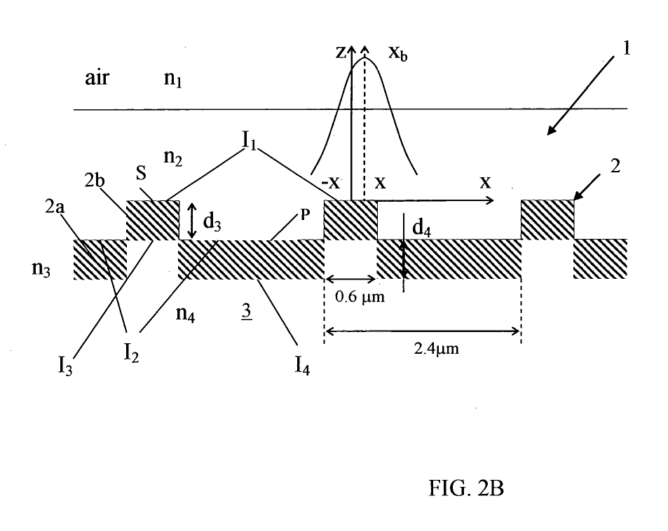

Reference is made to FIG. 2A showing an example of the reference layer structure 2 underneath a recording layer 1. The reference layer structure 2 includes a first material layer 2a which is a dielectric layer, which has a patterned surface 2b presenting two interfaces with the recording layer 1. Provided below layer 2a is a second material layer 3 (e.g., glue) providing a third interface. The recording layer structure 1 is formed by an appropriate polymer matrix with optically active material (e.g. ePMMA-based chromophoric medium) having a refractive index n₂ and in this example is an uppermost layer interfacing with air (refractive index n₁), layer 2a of the reference layer structure has a refractive index n₃, and glue material 3 has a refractive index n₄. It should be noted that the refractive indices of the recording and glue layers' materials may be substantially equal. The patterned interface 2b includes pits P of a depth d₁ and spaces (or spacers) S between them. The reference layer structure 2 shown in this figure thus has three well-defined interfaces in the light propagation scheme located at different depths from the recording layer: the first interface I₁ defined by the spacer plane (the bottom surface of the recording layer), the second interface I₂ defined by the bottom of the pit at the depth d₁ from the first interface, and the third interface I₃ being an interface between layers 2a and 3 at a depth d₂ from the second interface.

This simplified example is provided for explanation purposes. If the reference layer structure is designed such that d=(d₁+d₂)=m(λₒ/2n₃)+λ₀/4n₃ (where λₒ is the vacuum beam wavelength, n₃ is the refractive index of the reference layer material, and m is a positive integer), then there will be dominant constructive interference between light reflections A and C from interfaces I₁ and I₃. In case the depths are selected such that d=(d₁+d₂)=m(λₒ/2n₃), there will be dominant destructive interference between light reflections A and C from interfaces I₁ and I₃. In case, the depth d₁ is selected such that d₁=λₒ/4n₂ (where n₂ is the refractive index of the recording material) there will be destructive interference between light reflections A and B from interfaces I₁ and I₂. In practical implementation, pit structure may slightly vary as it is more complex and depends on the manufacturing process, and has to be fully accounted for by computation and measurement.

FIG. 2B shows another example of the reference layer structure 2 underneath a recording layer 1. The reference layer structure 2 includes a first material layer 2a, which is a dielectric layer, which has a patterned surface 2b presenting an interface with the recording layer 1, and has a certain thickness. A second material layer (support) 3 (e.g., glue) is provided below the reference layer structure. In this example, the depth of (embossed) pits d₃ is approximately 140 nm, and the width of the pits, designated by 2x, is 0.6 um. The dielectric coating d₄ is approximately 140 nm thick and has refractive index 2.0. In this example, the coating defines four interfaces at two different optical depths: interface I₁ between the recording layer 1 and the dielectric layer 2a surface closer to the reference beam source (upper surface of the space region S); interface I₂ between the recording layer 1 and the dielectric layer surface farther from the reference beam source by a distance d₃ (upper surface of the pit), interface I₃ between the dielectric 2a and adhesive layers 3 (with refractive index matching that of the recording layer, n₂=n₄) closer to the reference beam source (bottom surface of layer 2a within the space S); and interface I₄ between the dielectric 2a and the adhesive layer 3 surface farther from the reference beam source by a distance d₄ (bottom surface of layer 2a within the pit P). In this specific but not limiting example, since d₃=d₄, interfaces I₂ and I₃ lie in the same optical plane. Coatings of different thickness may, however, position the interfaces differently.

The recording material is essentially non-absorbing for the reference beam wavelength, for the recording/reading wavelength(s), and for the response (fluorescent) wavelength. The reference layer(s) material(s), thickness, and topographical pattern are selected to be substantially transparent to the recording/reading wavelength(s) and to the response (fluorescent) wavelength, and also such that the reference layer structure is at least partially reflective (preferably at least 1%) for the reference beam wavelength. This means that for given values of the refractive indices used, the thicknesses of the materials defining the interfaces in the beam propagation path, namely the thickness of the first material 2a is selected so that the reflectivity of the reference layer structure at the wavelength of the reference beam is about 1% or more. Also, the reference layer structure 2 is configured to have the reflectivity less than 30%, preferably less than 10%, more preferably less than 3%, most preferably less than 1% (e.g. not exceeding 0.1%), for the wavelength of recording/reading beams and for the wavelength of the (fluorescence) response.

The bonding layer 3 serves to adhere a plurality of recording layers (plates) 1 (together with their associated reference layer structure(s) 2) to each other. This layer 3 may be a non-fluorescent layer (i.e. which is not intended to recording/reading data therein), or may also be a fluorescent layer against reading/writing beam with a material composition similar or different from the main recording layers (plates) 1. The bonding layer 3 is highly transmitting for the wavelength(s) of the reference beam and the recording/reading beam. For example, as the material of the bonding layer, a methyl methacrylate copolymer (PMMA), a photo-cured acrylic, or a photo-polymerizing adhesive silicone resin may be employed.

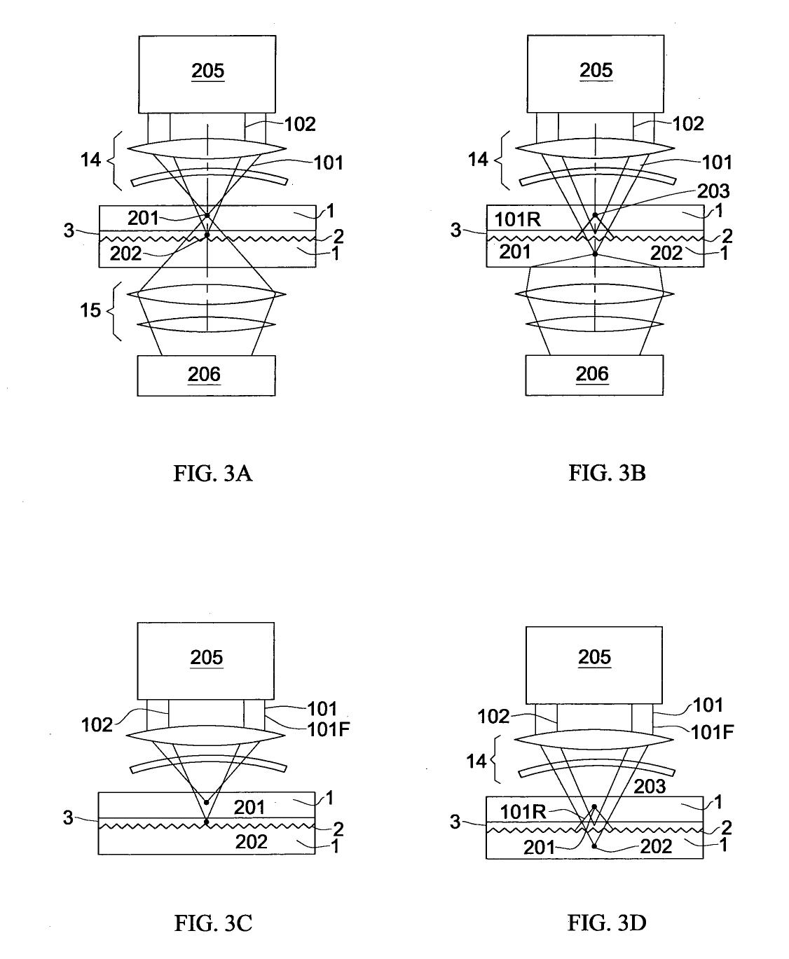

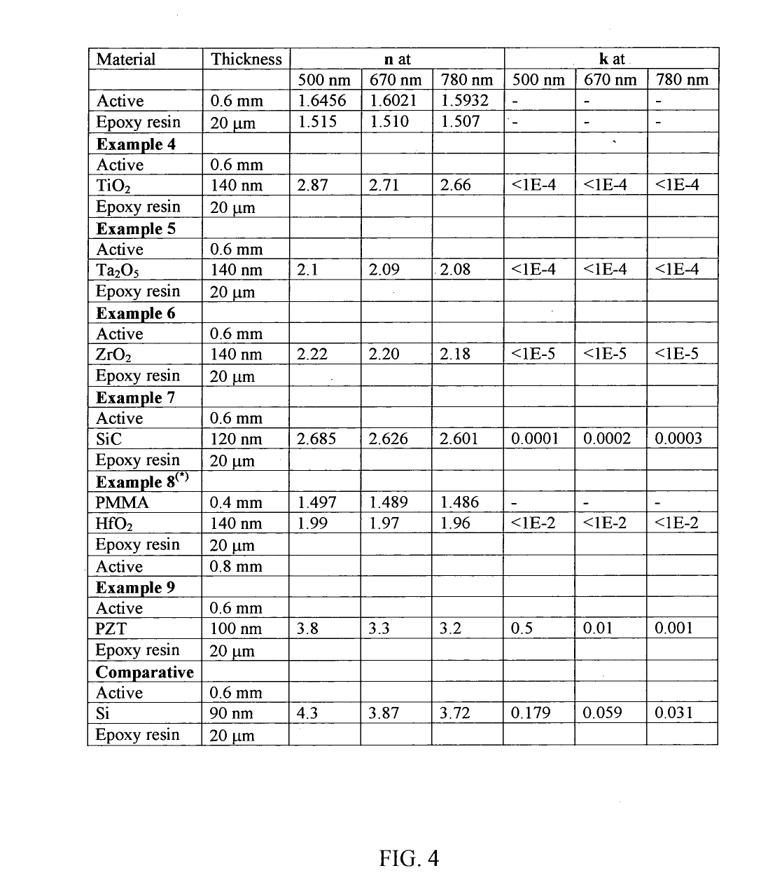

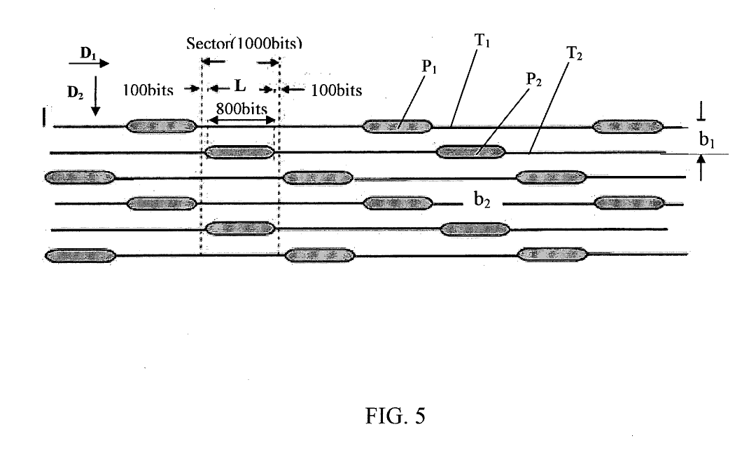

Reference is made to FIGS. 3A, 3B, 3C and 3D exemplifying a method for recording information to and reading information from a data carrier of the present invention.

FIG. 3A illustrates a recording/reading process in a volume 201 above a reference layer structure 2. A recording/reading beam 101 and a reference beam 102 propagate through the recording or reading volume 201. The reference beam 102 is focused by an objective lens system 14 on a reference track 202. Since the size of the focused spot in the focal direction is typically larger than the distance between the interfaces within the reference layer structure, the signal is a result of focused interaction with the at least three interfaces of reference material 3. Reflection of the reference beam is collected to a light detector (not shown). The objective lens system 14 is movable according to a servo system that controls the focused position of the recording/reading beam. While reading, the fluorescent light, or other optical response, which may, for example, be the result of other non-linear interactions, is gathered by a light-collecting lens system 15 and transferred to a detecting unit 206.

FIG. 3B illustrates recording or reading in a volume 201 below the reference layer structure 2 by a recording/reading beam 101 using a reference beam 102. A beam 101R represented by dotted lines is a reflected light of the recording/reading beam from the reference layer structure 2, and a volume 203 corresponds to a real image of the focused point.

FIG. 3C illustrates recording or reading in a volume 201 above the reference layer structure 2 by a recording/reading beam 101 by the aid of a reference beam 102. In this system, during the data reading process, fluorescent light is gathered by the objective lens system 14 and transferred to an optical unit 205. The fluorescent light is separated from other light spectra and detected.

FIG. 3D illustrates recording or reading in a volume 201 below the reference layer structure 2 by a recording/reading beam 101 by the aid of a reference beam 102. The response light is collected by an objective lens 14 and is separated from other light spectra and detected in an optical unit 205

In all the above examples, a focus point of the recording/reading beam is set in a determined relation, according to the objective optical axis, with the reference beam guided by a reference track.

The reference layer structure 2 has optical properties such that reflection of the reference beam within the reference layer structure is strong enough to enable detection of a focus error signal and a tracking error signal. This is achieved by providing proper material(s) within the reference layer structure, proper thickness(es) of the material(s), and proper topography (pattern) of interfaces.

It is preferable for the reference layer structure that the absorption of a recording/reading beam at the reference layer structure is as low as possible, because not only the intensity and quality of the beam may decrease while the beam propagates through the reference layer structure, but also the absorption of this beam may generate heat that may lead to impairment or even the destruction of the function of the reference layer structure if the beam happens to focus on or near the reference layer structure. If a part of the reference layer structure was destroyed, the related zone (i.e. that of the recording layer vertically aligned with the destructed part) could not be recorded in or read with accuracy.

As indicated above, it is preferable for the reference layer structure of the optical data carrier of the present invention that the reflection of the recording/reading beam at the reference layer structure is as low as possible (substantially less than 1%, preferably about 0.1% or less). This is because not only the intensity and quality of the beam decrease while the beam goes through the layer, but also because such reflected light may cause undesired interaction with the carrier or the optical system.

It is also preferable for the reference layer structure that the absorption and reflection of the interaction response, e.g. the fluorescent light generated by the action of reading beam, at the reference layer structure is low, because a decrease in the intensity of the fluorescent beam while the beam propagates through the layer leads to a decrease in SNR. The reference layer structure is configured to be substantially transparent (non-absorbing, and almost non-reflective) and stable to the recording/reading beam.

The reference layer structure can be constructed from a thin layer of dielectric material on a patterned substrate, the thin layer having a thickness such that it is substantially transparent at the wavelengths of the recording/reading/fluorescent beams. Selectivity between the responses to the different light beams is achieved by appropriate choice of materials and by accurate control of the thin layer thickness and topography.

As described, in the information carrier of the present invention, the reference layer material(s) should be largely non-absorbing at the recording/reading wavelength. This is accomplished by using dielectric materials as reflective materials. On the contrary, in conventional optical disks (such as Laser disk, CD, CD-R, DVD-R, DVD-RAM, BD, HD-DVD, or MO) metals (such as aluminium, silver, gold, metal alloys, or metal compounds) that absorb a recording/writing beam have been used as reflective materials. Although dielectric materials, such as ZnS/SiO2, have been used for a protective layer for phase change materials in phase change type optical disks, materials designed for reflectivity in such media are intermetal compounds such as TeGeSb, SbTe, InSe, GeTe and InAgSb. On the contrary, in the optical data carrier of the present invention, dielectric material is preferably used to impart reflectivity.

The complex index of refraction is generally used to describe the interaction of electromagnetic radiation with matter. This parameter is a combination of a real part and an imaginary part:

Complex index of refraction=n−ik

wherein n is the real part, or index of refraction, i is the imaginary unit, and k is the imaginary part, or extinction coefficient. The values of n and k are wavelength dependant and coupled, as described by the Kramers-Kronig relation.

Dielectric material is a material that has a low extinction coefficient. For the purposes of the invention, reference layer materials are selected to have small extinction coefficients. Materials with k<0.01, more preferably with k<0.001, even more preferably with k<0.0001 at the wavelength range of the recording/reading/fluorescent beams are preferable.

The amount of reflection is controlled by a proper choice of the material(s) in the reference layer structure, the thickness of the material layer(s) in the reference layer structure (e.g. the thickness of the patterned material 2a), and the interfaces within the reference layer structure, in particular by controlling the position of the focus point relative to the reference layer interfaces. Choosing the right thicknesses and pattern parameters (e.g. pit/groove width and track pitch) can greatly improve the reference layer tracking SNR. In order to obtain a tracking error signal, an average reflection of the reference beam from the reference layer of greater than 1% is preferable, and the pattern should be properly designed to enable its identification. The difference between the real part of the refraction indices of the reference layer material and interfacing recording layer material should be greater than a critical value. If the difference is smaller than the critical value, the reflection may be too low. The real refractive index difference is preferably greater than 0.3, and more preferably greater than 0.5, however, in some cases a refractive index difference as low as 0.2 may be used. In a typical recording material, the real part of the refractive index of the recording material is between 1.4 and 1.7. Therefore, the real part of the refractive index of the reference layer material is to be greater than 1.9 or smaller than 1.4, depending on the performance of the recording material. In a typical case, the value is preferably greater than 2.0.

In contrast, reflections of the recording/reading beam and the fluorescent signal are preferably minimized. As described previously, reflections from the front and back interfaces of a reference material film interfere largely destructively when the film thickness d=λ₀/(2n₃). Assuming that both the fluorescence wavelengths and the recording/reading wavelength are less than (or greater than) the reference wavelength, the film thickness can, therefore, be tuned such that a minimum in reflectivity occurs at a wavelength intermediate to the fluorescence and recording/reading wavelengths. Additionally, in the special case where the real refractive indices at wavelength λ₀ of the two materials adjacent to the reference layer are identical (n₂=n₄ in FIG. 2), the minimum reflectivity at λ₀=2dn₃ will be nominally zero, thereby minimizing the reflectivity at neighboring wavelengths for fixed values of d and n₃. Any other structure aiming at minimizing the reflectivity at this wavelength range would be more complex or would require more complex material behavior (e.g. strong dispersion of the refractive index). Thus, the adhesive material and the support material (when applicable) should be selected such that the difference between their real refractive indices and the refractive index of the recording material is preferably less than 0.1, and more preferably less than 0.03.

Depths of embossed patterns (pits and spaces) are typically selected to enable certain tracking method(s) e.g. a system may be optimized for push-pull signal (typically around λ/8), for sampled servo signal (typically around λ/4), or may be designed as a compromise that allows for different types of tracking (e.g. around λ/6). The selection of the dielectric layer thickness is coupled to the pattern dimensions, e.g. the thickness of the dielectric limits the pit depth. To minimize wavefront deterioration, the pits and/or grooves are preferably sparse with reference layer fill factor (pit/groove area to total area) less than 5-10%.

Some examples of materials for the reference layer that meet the above requirements are metal chalcogenides such as TiO₂ (n=2.71, k<<0.04 at 660 nm), ZrO₂ (n=2.201, k=0.5×10⁻³ at 670 nm), Ta₂O₅ (n=2.25, k=0 at 633 nm), HfO₂ (n=1.9108, k=0 at 650 nm), Y₂O₃ (n=1.921, k=0 at 660 nm), ZnS (n=2.35, k=3.6×10⁻⁶ at 650 nm), complex metal oxide such as LaTiO₃ (n=2.06, k<<0.0002 at 740 nm), ITO (n=1.9360, k=0.01597 at 550 nm), PZT (n=2.3972, k=0.0026 at 680 nm, metal carbide such as SiC n=2.62, k=0.0002 at 600 nm), metal nitride such as Si₃N₄ (n=2.17, k<<0.0001 at 670 nm) and AlN (n=2.005, k<0.0001).

It should be noted that refractive index n, as well as extinction coefficient k, varies with the process used for forming the film and with the quality of the interface. The above indicated values present typical data, but in order to get a sufficient result, proper conditions (e.g. providing a sharp interface) need to be selected.

Even when the real part of the index of refraction is greater than the critical value, if the thickness of the reference material is not proper, proper (sufficiently large or small) reflection may not be obtained. Furthermore, the reflectivity depends on the wavelength of incident light and, as noted above, on the destructive or constructive interference between the reflections from the at least two surfaces of the reference layer. Therefore the thickness(es) of the reference layer materials) should be selected to provide sufficiently high signal to noise ratio.

Controlling the amount of reflection from the interfaces of the reference layer structure can be improved by using additional very thin interfacing layers to control the refractive index profile of the interface, thus, for example layers (coatings) on the order of 10 nm thickness can controllably increase or reduce the amount of reflection at each interface. Thus, reflection at the fluorescence wavelengths and the reading/recording wavelength(s) can be reduced and/or reflection at the reference beam wavelength can be increased, for example by use of a SiO₂ coating of a 20 nm thickness (n being about 1.5) between the recording layer and a 140 nm main reference layer 2a (see FIG. 2B).

The processes of the invention for forming an optical storage media involve Primary Processes by which the components of a disk are formed, Secondary Processes by which the components of the disk are assembled, shaped, and finished into the final product, and methods that may be used in one or more primary or secondary processes for incorporating one or more active layers into the disk. Further examples of producing such optical storage media are provided below.

According to one example, chromophores can be chemically bound to a substrate layer to achieve a structured, ordered memory as described in US patent application US 2005/0254319, including the formation of acrylic/chromophore monomers that can then be polymerized. One method for applying the active chromophores would be by a coating or printing operation, in which a solution (solvent or emulsion) is coated or printed on one or both sides of a substrate layer (which could optionally contain a tracking and/or reference layer). The active material could be cured following application. The substrate layer could be a film or sheet, and multiple layers of the coated/printed substrate layers could be stacked to form a single disk. The advantages of this method include precision application, and reduction of thermal stress.

According to another example, chromophores can be copolymerized with one or more acrylic monomers to form a random copolymer. The random copolymer could be used neat, or can be blended with non-active material, preferably acrylic polymer. The copolymer, or copolymer blend, can be sandwiched between two non-active support layers to provide a three-dimensional storage medium. The copolymer layer could also be a separate film or sheet layer that is placed between layers of non-active support material, or several active layers could be stacked between non-active support layers. The active copolymer may also be blended into a non-active polymer matrix, forming a homogeneous layer. The active chromophore containing copolymer may also be dissolved into a non-active or active monomer mixture, then polymerized into a polymer matrix, forming a homogeneous layer, or an interpenetrating network.

According to yet another example, core-shell type polymer particles can be formed. In one embodiment, the active (chromophore) material or random copolymer can form a core material that is then coated with a polymer that has mechanical integrity superior to the active material forming core-shell type particles. These particles can be blended with a non-active material to form a homogeneous layer containing the active material. Alternatively, the active (chromophore) material or copolymer could form the shell material coating of a selected core non-active copolymer. Such core-shell particles could then be blended with active material to also form a homogeneous layer containing a high concentration of active material. This layer can be in a film or as part of a sheet. The location of the active layer in the disk can range from a large single layer sandwiched between two support layers to multiple layers containing active material stacked within the disk, with or without non-active layers.

In yet a further example, the active (chromophore) material can be copolymerized with a non-active material that is immiscible with the active material and has superior mechanical integrity to form a block copolymer having two or three blocks. Processing the block copolymer under certain conditions will promote ordered phase segregation on a sub-micron scale. The composition of the active and non-active blocks can be tuned to match the refractive indices of the segregated phases for optical clarity.

Polymer chains with a high concentration of bulky pendant groups are inherently stiff, leading to macroscopic brittleness. In a further possible example, blocks of active (chromophore) random copolymer can be separated by short flexible spacers to increase the flexibility of the chains to form flexibly linked stiff segments that can more easily entangle, allowing for enhanced toughness. For example, difunctional oligomers of active random copolymer can be reacted with difunctional alkanes or other flexible difunctional small molecules to form a polymer with improved mechanical integrity.

The reference layer structure(s) may be incorporated into the disk by different techniques. One skilled in the art, based on the present disclosure, could envision other similar processes. Typically, the required embossed pattern is generated by carrying out a Primary Process, as described below, in the presence of a stamper, or by conducting a hot compression or hot embossing step in the presence of a stamper after a Primary Process has been completed. Alternatively, the patterning can be conducted by nano- or micro-lithographic and nano- or micro-imprintation techniques, utilizing photo-definable resists and direct scanning of an electron beam using judiciously selected electron-definable resists.

As described in more detail below, the reference layer reflecting surface may be formed by a film with low reflectance on a pitted/protruded surface, which is formed in the substrate using a stamper. The reflecting surface may also be formed by a difference in refractive indices of the substrate and adhesive layer 3. The reflecting surface pattern provides positional information concerning the radius and tangential directions within the disk.

In other embodiments, a coating suitable to form a desirable refractive index difference may be spin coated, dip coated, or applied as a film laminate. Yet another option utilizes deposition of films by conventional processes such as vapor deposition, sputtering, chemical vapor deposition, e-beam deposition, ion plating, plasma assisted deposition, and sol-gel processes.

There are many suitable techniques by which an optical disk containing active material may be fabricated. Many of these methods involve the production of a thin layer, both film and sheet, and active or non-active, which can then be laminated with other layers to form the disk. Some of the suitable processes include, but are not limited to, either one of the following listed processes or combinations thereof: injection molding, transfer molding, reaction injection molding, compression molding, film adhesion or lamination, cast polymerization and extrusion/coextrusion or rod profile extrusion, bulk molding or solvent (and optionally continuous) cast sheet. Those skilled in the art can imagine still other possible constructions and techniques for producing those constructions.

Also, clear layers of non-acrylic polymers could be added to improve the toughness of the overall disk. Polymer layers such as polycarbonates or polyesters could be used as clear inactive support layers to improve toughness. These layers may not contain active material, but would function to enhance the overall physical properties.

Compression molding has also been used for embossing a reference layer structure onto a disk. Polymer disks with high optical quality surfaces can be molded against highly polished glass or metallic plates.

In each of the methods, or by combining single layers or films, a certain component itself could contain multiple layers.

Each of the Primary Processes for forming a polymeric layer can be combined with one or more Secondary Processes to achieve improved performance and to produce the desired disk thickness. These Secondary Processes include, but are not limited to film or layer adhesion or lamination, cutting to shape, stamping/coining, coating, compression molding (for assembling), welding and printing (e.g. printing chromophoric active layer or glue or interface layers).

The use of the films can add scratch resistance and toughness to the disk. The optically clear films can be as thin as 2 micrometers. The film may not contain active material, but would improve the physical properties of the disk, such as scratch resistance, heat distortion temperature, toughening, UV screening, water permeability, and anti-reflection. Lamination or adhesion of an optically clear film as above can also be applied as one or more interlayers, to increase the toughness of the disk.

A further advantage of film lamination is that when the film contains the active layer, the total storage capacity would be a function of the number of film layers applied to a substrate. Then, one disk could use a single film layer and have a lower capacity (for instance 200 gigabytes), while another final disk could be formed from multiple layers of film and have a larger capacity of over a terabyte. A further advantage of the use of thin layers is that the physical depth of recorded layers can be made smaller than the depth of focus of the recording or interrogating beam, thus enabling higher data density in the optical axis direction.

The following examples are illustrative of the invention but are not intended to be exhaustive or to limit the invention to the precise form disclosed. Many other variations and modifications are possible in light of the specification and examples.

The following monomers are used in the Examples:

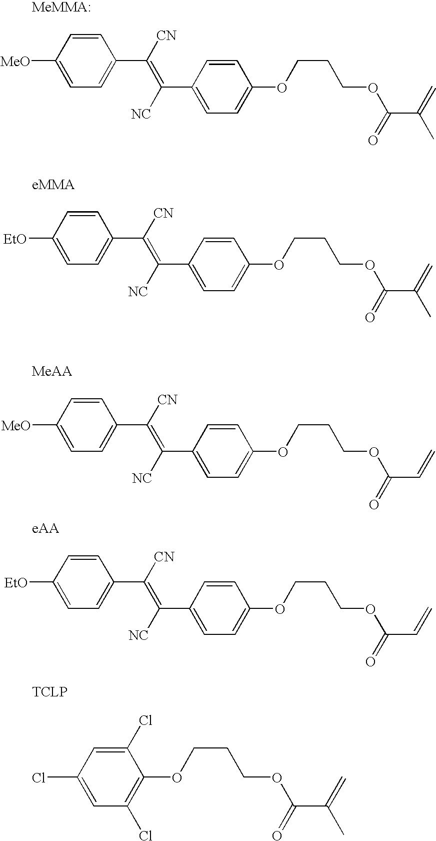

Combinations and polymerization of such monomers result in materials generally called ePMMA.

### Example 1

### Cast Polymerization

A prepolymer solution was created by combining 10 g chromophore MeMMA, 90 g methyl methacrylate (MMA) and the following free radical initiator package for one hour: 0.003 g AIBN, 0.03 g Lupersol 70, 0.05 g Lupersol 11, and 0.0005 g Lupersol T-BPO. A mold was made with two optical glass plates, spring clips, and a gasket with a thickness of 5.5 mm. A CD stamper was attached to the inside surface of one of glass plates in order to create a spiral pattern of pits to the molded article. This setup was then filled with the prepolymer solution using a syringe and heated overnight at 61° C. After approximately 24 hours, the temperature was increased to 125° C. for 1.5 hours to minimize residual monomer.

The resulting molded article was free of bubbles with a very good surface and a thickness of 3.5 mm. The stamper pattern was successfully transferred to the polymers, as verified by SEM and AFM. The optical transmittance of this product was approximately 77%.

### Example 2

### Compression Molding

The polymer made by suspension polymerization and containing 10% of chromophore eMMA and 90% of MMA was formed into a disc by compression molding. The mold cavity used had a thickness of 0.6 mm and a diameter of 120 mm.

The mold was subjected to the following protocol on a pneumatic press at 180° C.:

plates nearly closed for 1 minute to soften polymer

plates closed at 1,000 lbs force for 1 minute

the press is then opened briefly to allow trapped gas to escape

plates closed at 1,000 lbs for 1 minute

plates closed at 10,000 lbs for 3 minutes

The mold was then transferred to a room temperature press to cool under pressure for 5 minutes.

The resulting disc released easily from the mold without breaking. No bubbles were observed within the sample. The transmittance of this product was approximately 92.5%.

Compression molding was also performed with a CD stamper in which case the pattern of pits was successfully transferred.

### Example 3

### Reflectivity of Immersed Thin Dielectric Films

Films of tantalum oxide and zirconium oxide with thickness approximately 140 nm are deposited by an e-beam evaporation process onto polycarbonate sheet with an optical quality surface. A drop of oil with refractive index closely matching polycarbonate (n_{D}=1.586) is placed on the films and covered with an uncoated polycarbonate substrate. The reflectivity spectra of the films of tantalum oxide and zirconium oxide between two substrates with identical refractive index reveal that the immersed films exhibit substantially zero reflectivity for radiation having a wavelength of approximately 550 nm.

TABLE 1

| | Reflectivity % | | |
|---|---|---|---|
| Material | at 780 nm | at 670 nm | at 500 nm |
| Tantalum oxide | 2.6 | 1.1 | 0.5 |
| Zirconium oxide | 1.5 | 0.7 | 0.3 |

Multi-layer structures such as illustrated in FIG. 1A or FIG. 1B were fabricated. A reference track was in the form of a spiral groove of 90 nm depth. The wavelengths of a recording/reading beam and a reference beam were 671 nm and 780 nm respectively, and the wavelength of fluorescence was approximately 500 nm. Table 2 below summarizes the measurement of the Reflectance % for different examples of reference layer materials. Detailed structures for each example is provided in table 3 referred to below.

TABLE 2

| | |
|---|---|
| Reflective | Reflectance % at |

| Example # | layer Material | 500 nm | 670 nm | 780 nm |
|---|---|---|---|---|
| 4 | TiO₂ | 12 | 1 | 4 |
| 5 | Ta₂O₅ | 4 | 1 | 4 |
| 6 | ZrO₂ | 6 | 1 | 4 |
| 7 | SiC | 17 | 4 | 7 |
| 8 | HfO₂ | 1 | 1.5 | 3.5 |
| 9 | PZT | 28 | 1 | 15 |
| 10 | Si | 23 | 5 | 20 |

FIG. 4 provides a table (Table 3) with a summary of the structures measured and their measure of n and k at wavelength of interest. The measured parameters of active layer and the epoxy layer are listed in the first rows of Table 3. The optical carriers are configured as exemplified in FIG. 1A, except for example 8 where the optical carrier is configured as exemplified in FIG. 1B.

In the above reference layer composition examples (examples 4-9), good servo error signal using reference beam of 780 nm was obtained, and writing and reading could be performed by the aid of tracking of the reference beam. Even if the writing beam was focused very near the reference layer structure of the disk for a short period, tracking by using the reference layer was possible, demonstrating that sufficiently low absorption of the reference layer structure allows reading at proximity to the reference layer without its destruction.

Example 10 is a comparative example; where the recording beam with wavelength of 670 nm and peak power of 300 W was far from the reference layer, servo error signal using reference beam of 780 nm was detected and recording and reading processes could be performed. But after the recording beam impinged on the reference layer structure of the disk for a short period, serious deterioration on optical property was observed and tracking by using the reference layer became impossible.

The following are some additional examples for the reference layer material.

Lithium Tantalate (LiTaO3): n=2.18 for wavelength of 33 nm, transparent 400-5500 nm

Lithium Niobate (LiNbO₃): n=2.28/2.20 for wavelength of 633 nm, transparent 350-5500 nm

Bismuth Germanate (Bi4Ge₃O₁₂): n=2.1 for wavelength of 633 nm, transparent 300-5000 nm

Niobium Pentoxide (Nb₂O₅): n=2.17 for wavelength of 589 nm, colorless

Praseodymium Pentoxide (Pr₅O₁₁): n=2.1 for wavelength of 550 nm

Diamond (C): 2.42 for wavelength of 589 nm, colorless

Cryolite (Na₃AlF₆): n=1.34 for wavelength of 589 nm, colorless

Teflon AF (DuPont polymer): n˜1.3 for wavelength of 589 nm, non-absorbing at greater than 400 nm

Lightspan LS-2233-10: n˜1.33 at 589 nm, non-absorbing at greater than 400 nm.

### Example 11

### Conformity of Thin Films to Patterned Substrates

Films of tantalum oxide and zirconium oxide deposited by an e-beam evaporation process onto polycarbonate sheet patterned with a spiral CD pattern of pits (approximately 115 nm deep) were examined by atomic force microscopy to measure thin film conformity. The films were observed to largely conform to the surface pattern as exemplified by selected measurements of pit depth by AFM; uncoated pits were measured to have average depth of 115.6 nm+/−1.6, Tantalum oxide thin films measured 115.5 nm+/−1.4 and Zirconium oxide thin films measured 107.1 nm+/−0.9.

As an example of a reference layer pattern, reference is made to FIG. 5. Pits are embossed in polycarbonate along a spiral track, where pits (grooves, or pit sequences) are significantly longer than the diameter of the interrogating beam. Tracks are embossed with a radial pitch of 0.8 μm. Because of the lateral shift of pits in consecutive tracks, an interrogating beam is practically unaffected by pits at neighboring tracks, and in actuality, a period or track pitch in radial direction is 3 times larger than the period of tracks, i.e. 2.4 μm.

Turning back to FIG. 2B, the structure (relief pattern and thickness) of the reference layer is illustrated by a radial section through the disk and supports a description of the method for estimating the response of disk to a reference beam focused at the reference layer.

Depth of embossed pits d₃ is approximately 140 nm, and the width of the pits, designated by 2a, is 0.6 um. The dielectric coating d₄ is approximately 140 nm thick and has refractive index 2.0. The coating defines interfaces at four different optical depths: (i) interface Iᵢ between the recording layer 1 and the dielectric layer 2a surface closer to the reference beam source; (ii) interface I₂ between the recording layer 1 and the dielectric layer surface farther from the reference beam source by a distance d₃, (iii) interface I₃ between the dielectric 2a and adhesive layer 3 (with refractive index matching that of the recording plate, n₂=n₄) closer to the reference beam source; and (iv) interface I₄ between the dielectric 2a and the adhesive layer 3 surface farther from the reference beam source by a distance d₃. In this instance, since d₃=d₄, interfaces I₂ and I₃ lie in the same optical plane, coating of different thickness may, however, position the interfaces differently.

Reference is made to FIG. 5, exemplifying the lateral arrangement of the features of the pattern in the reference layer structure. As indicated above, the pattern in the reference layer structure may be in the form of spaced-apart pits arranged along a spiral or along concentric rings, where the spiral track or concentric rings may or may not be defined by continuous grooves. The segments of the spiral path or the concentric rings define multiple tracks T₁, T₂, etc. along which the pits P₁, P₂, etc. respectively are arranged in a spaced-apart relationship. The inventors have found that in order to enable effective control of the recording/reading process by using the reference layer structure, the arrangement of the pattern in the reference layer structure in the plane of the layer structure (across the carrier) should preferably be appropriately selected. Such parameters of the pattern as the track pitch (distance b₁ between adjacent spiral segments or concentric rings T₁, T₂), a space b₂ between the consecutive pits P₁ (P₂, etc) along the track (i.e. a distance in a tangential direction D₁), a length L of the pit, and a distance b₃ between the pits in adjacent tracks (i.e. a distance in a radial direction) are appropriately selected to provide desirable high response of the reference layer structure (i.e. reflection of the reference beam from the reference layer structure). It should be noted that the elongated pit shown in the figure might constitute a single pit or a group of discrete pits. In the latter case, the pits of the group are spaced from one another a distance smaller than a distance between the groups along the track.

To estimate the response of the reference layer structure to the interrogating reference beam, the reference beam is approximated as a Gaussian beam centered at x_{b} with a waist w₀ (beam radius at 1/e² intensity level). As shown in FIG. 2B, the width of the groove is 2a and the groove edges are marked by −x and x (in the radial (x) coordinate). Depth of the RL in the disk is 0.6 mm, lens NA=0.7, and lens diameter is 5 mm. The reference layer is substantially thinner than the depth of focus of the reference beam and is approximated to be fully within the focus center.

As shown in FIG. 5, the above parameters of the pattern within the plane of the reference layer structure are selected such that the pits do not overlap along the radial direction D₂. The elongated pit P (of a 800 bits' length) is accommodated with certain gaps (of 100 bits) at opposite ends thereof, thereby defining a “sector” (1000 bits). The arrangement of the features of the pattern may be in a sequence of marks (pits) and spaces, enabling additional information encoding. Alternatively, the non-overlapping servo pits stricture can be restricted to certain periodically repeating regions of the reference layer surface, allowing recording of additional information in intermediate regions.

The focused beam response is estimated by diffraction modeling using Huygens-Fresnel-Kirchhoff theory; see for example E. Hecht, Optics, 4^{th} edition Addison Wesley, 2002.

For a constant 140 nm thickness of a dielectric with n=2.0 between a flat polycarbonate substrate and a flat recording plate the amount of reflection of the 780 nm reference beam is estimated by calculation to approximately 3.5%, the amount of reflection of the 660 nm recording/reading beam is less than 1% and the amount of reflection of the fluorescent light centered around 520 nm is less than 1% in reasonable agreement with measured values, providing the required transparency of recording/reading beams and fluorescence and the required reflectivity of the reference beam.

The thickness of the deposited dielectric layer is constant, and therefore the structure illustrated by FIG. 5 is substantially a pure phase structure (i.e., a structure that spatially modulates only the phase of the reflections). It should be noted that a reference layer structure with different thickness of the dielectric in the pit and space positions (i.e., one that spatially modulates the amplitude and phase of the reflections) can also be implemented, including the specific embodiment in which interfaces I₁ and I₂ or interfaces I₃ and I₄ are coplanar as portrayed in FIG. 2B.

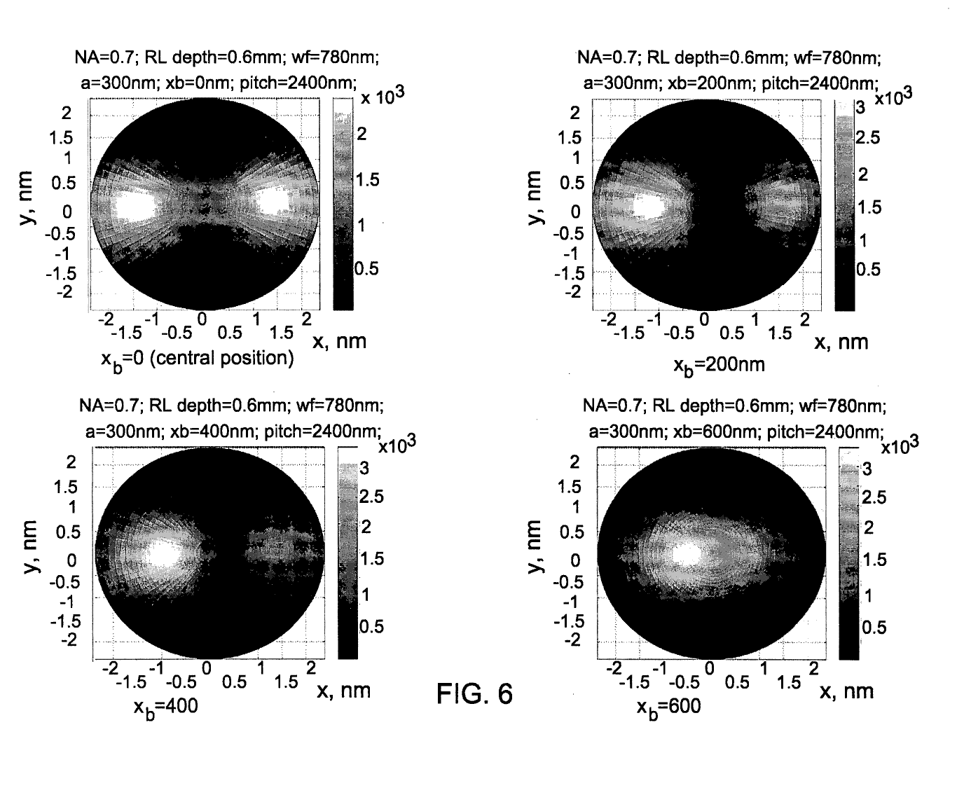

The power distribution of the reflected reference beam is estimated inside the media and on a lens for different lateral positions X_{b} of the reference beam relative to the center of the track for 0<x_{b}<1200 nm. Representative distributions are shown in FIG. 6.

The image power distribution of the reflected light changes as a function of the reference beam position relative to the track. The reflected light has two strong symmetric first order lobes when the beam is in the central position. As the reference beam offset from the central position increases, the lobes become asymmetric and the inter-peak spacing decreases until their confluence.

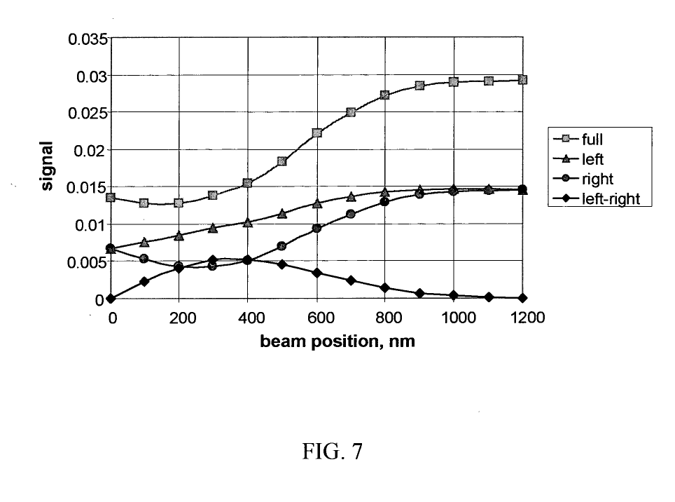

Integrals of the power distributions on the lens were estimated for the left A and the right B sides (relative to the track direction) as a function of the beam focus offset in the radial direction relative to the track as shown in FIG. 7. The full signal (A+B) and the difference of the left and the right signals (A−B) are also indicated in FIG. 7.

A track error signal, defined as

$$TE = \frac{A - B}{A + B} ,$$

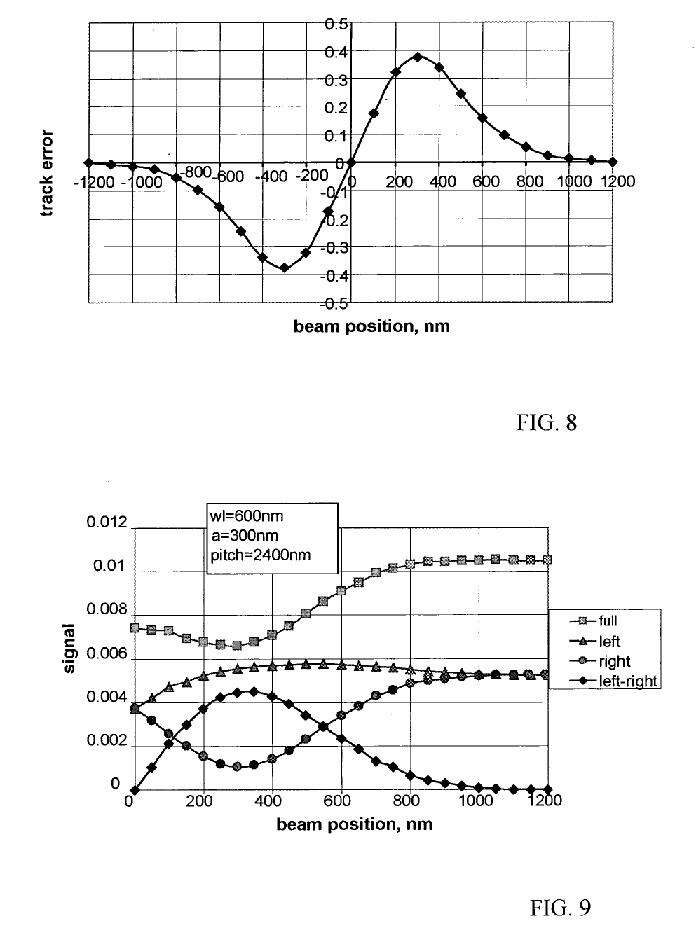

can be described by an S-curve as shown in FIG. 8 (see A. Merchant, Optical recording: A Technical Review, Addison-Wesley, 1990). The slope of the S-curve is approximately 0.18 per 100 nm offset (i.e., 1.8 μm⁻¹) in the range +/−200 nm.

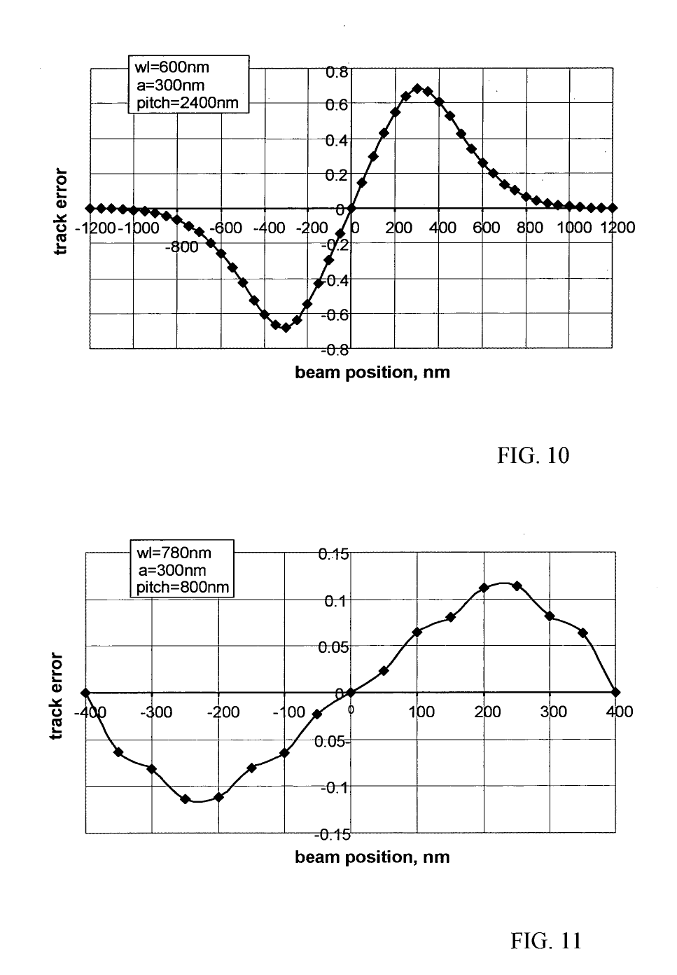

The exemplified structure enables extracting positional information of the beam response also for the recording/reading beam at 660 nm as shown in FIGS. 9 and 10. The integral of the response can be used for sampled servo tracking (in the radial direction) as disclosed in separate U.S. provisional application 60/938,510 (assigned to the assignee of the present application) or by using a sectioned (image position sensitive) detector such as a bi-sectioned detector. Focus tracking based on the interaction of either the reference or the recording/reading beams can use for example conventional (e.g. aspheric lens) focusing.

The response of the reference layer structure to the reference beam can be controlled by parameters such as distance between tracks (track pitch), overlap between marks (e.g. in the radial direction), embossing depth and width, embossing shape, dielectric coating thicknesses, and similar parameters. For example, tangential (along the track) overlap between marks (pits) in adjacent tracks can be considered. A reference layer structure, configured similar to that illustrated in FIGS. 2B and 5, but with marks overlapping in the radial direction (actual distance equal to the track pitch), produces a track-error signal described by an S-curve shown in FIG. 11 with inferior quality having, for example, a reduced slope by a factor of approximately 3.

In order to track the recording/reading beam propagation based on the reference layer structure, a tracking error signal at the required tracking signal band should have sufficient SNR, where the SNR is controlled among others by the signal strength and off-track error signal (in either focus or radial tracking directions), which among others is coupled to the used tracking method and system and to the pit modulation depth and possibly other on-track and off-track signals, such as mark and groove signals (generally referred to herein below as embossed pattern signals).

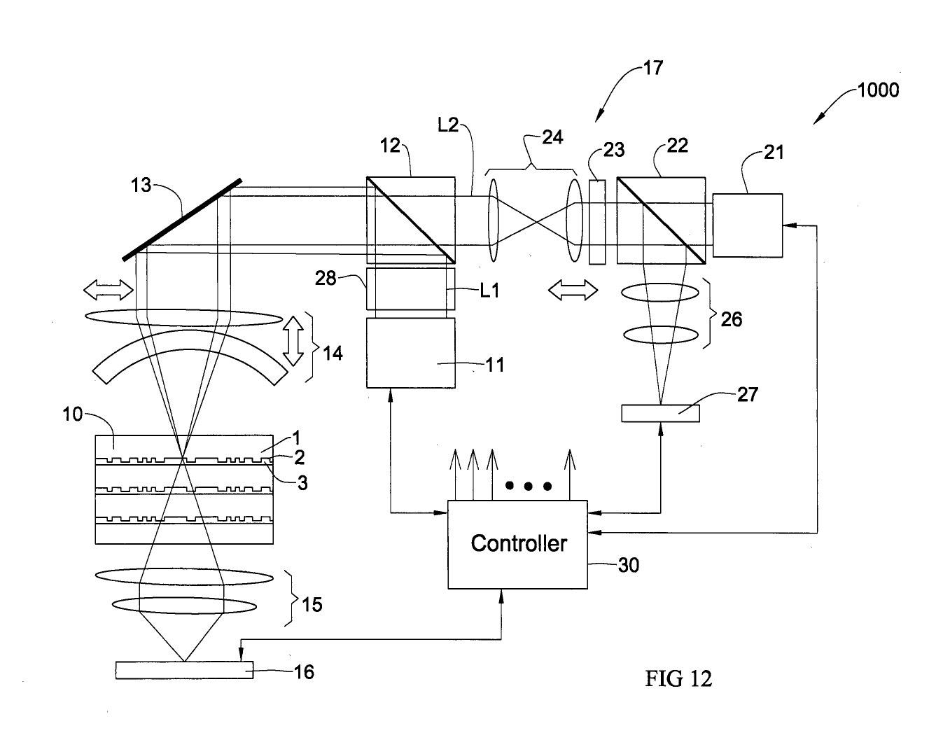

Reference is made to FIG. 12 illustrating an example of an optical system, generally designated 1000, for recording/reading data in an optical data carrier 10 of the present invention.

In the present example, the data carrier 10 includes multiple recording layers 1 arranged such that each recording layer 1 (except for the uppermost one) is located in between two locally adjacent reference layer structures 2. Also, in the present example, each recording layer 1 has its associated reference layer structure 2. It should however be noted that, generally, one reference layer structure may serve for more than one recording layer. The reference layer structure 2 is relatively reflective (as described above) for a reference beam and substantially transparent (non-reflective and non-absorbing) for recording/reading/fluorescent beams. The recording layer 1 is configured to enable creation therein of multiple recording planes.

The system 1000 includes a light source system formed by a first light source unit (laser) 11 operative to emit a recording/reading light beam L₁, and a second reference light source (laser) 21 operative to emit a reference light beam L₂. The system 1000 further includes a light detection system, which in the present example is formed by two detection units 16 and 27; and a light directing system, generally at 17, configured for directing and focusing the recording/reading beam onto a desired location in the medium 10 and for directing light returned from the medium (excited response and reflection of reference beam) towards the detection system. The detection unit 16 is associated with its collection optics 15 (formed by two lenses in the present example) and serves for detecting the light response of the medium to the reading beam. The detection unit 27 is also associated with its imaging optics 26 (e.g. two lenses) and serves for detecting reflection of the reference beam from the reference layer 2. Also provided in the system 1000 is a control unit 30, connectable to the light source system and to the detection system (via wires or wireless signal transmission as the case may be), and operating to adjust the operational mode of the light source system and receive and analyze the output of the detection system.

The recording/reading laser source unit 11 includes a light source capable of emitting light of a wavelength range suitable to cause the multi-photon interaction for the data recording/reading in the data carrier 10, for example a wavelength λ₁ of about 671 nm. The laser source 11 is configured for controllably varying the output thereof such that it selectively emits a light pattern suitable for recording and reading processes, for example light of an average output of 1 W and a pulse width of about tens of pico-seconds for recording and light of an average output of 1.0 W and a pulse width of about tens of pico-seconds for reading/reading.

The reference laser source unit 21 includes a light source operable for tracking servo and focusing servo of the data carrier 10. This light source emits the reference light beam (laser beam) L₂ of a suitable wavelength range (which may be different or not from that of the recording/reading beam), for example having a wavelength λ₂ of about 780 nm. The reference light source unit preferably also includes a polarized beam splitter 22 and a polarization rotator (e.g. ¼-wavelength plate) 23 in the optical path of the emitted reference beam L₂.

The light directing and focusing system 17 includes a beam splitter/combiner 12 in the optical path of the recording/reading and reference beams Lᵢ and L₂; a focusing optics 24 (formed by one or more lenses for example—two such lenses being shown in the present example) at the output of the reference light system configured for focusing the reference light beam L₂ (of the appropriate polarization) onto the beam splitter/combiner 12; and a focusing/collecting optics 14 (formed by one or more lenses—two such lenses being shown in the present example) for focusing the incident light (optical beam) onto a desired location in the medium and collecting light returned from the medium. Also preferably provided in the light directing and focusing system 17 is a controllably movable reflector unit 28 (e.g. mirror driven for movement by a piezo-element) accommodated in the optical path of the recording/reading beam L₁, for the purpose that will be described further below. Further provided is a mirror 13 accommodated in the optical path of the incident light propagating from the beam splitter/combiner 12 to direct it to the focusing optics 28 and to direct light returned from the medium and collected by optics 28 to direct it to the beam splitter/combiner 12.

The system 1000 operates as follows: The reference beam L₂ is directed towards the medium as described above, i.e. its polarization is preferably appropriately adjusted; and then it is focused by optics 24 onto the beam combiner 12, reflected by the mirror 13, and further focusing by the optics 14 onto a desired the reference layer 2. This reference light is reflected from the reference layer 2 and returns back through the same optical path, i.e. optics 14, mirror 13, beam splitter/combiner 12, optics 24 and polarized beam splitter 22. The latter reflects the reference beam L₂ to pass through the imaging lens 26 to the detector 27. Based on the output signal from the detector 27 (being analyzed by the controller 30), the focusing optical systems 14, 24 are controlled (by the same controller 30 or another control unit as the case may be) such that the focused position of the reference beam L₂ is always substantially coincident with the reference layer 2. Considering for example a four-part split detector is used in the detection unit 27, tracking control can be executed using a well-known push-pull method.

The recording/reading beam L₁ in turn passes the beam splitter/combiner 12, is reflected by the mirror 13, and focused by the focusing optical system 14 on the same reference layer 2 in the medium 10 as the reference beam L₂ focuses on. Specifically, the recording/reading beam L₁ is focused on the same reference layer 2 as the reference beam L₂, by operating the focusing optical system 24 to perform wobbling along the optical axis direction, as will be described below.

Next, by an operation of the piezo mirror 28, the recording/reading beam L₁ is focused on the same track as the reference beam L₂ is focused on, or a certain track related to it. In this situation, the reference beam L₂ is always focused on the reference layer 2 by an operation of the focusing optical system 14 controlled by the controller 30 as a servomechanism. Subsequently, by driving the focusing optical system 24, a focus position of the recording/reading beam L₁ in the data carrier thickness direction is moved by a certain distance. By controlling the intensity of the recording/reading beam L₁ to be of the intensity suitable for recording, the fluorescent property (constituting the medium excitation by multi-photon interaction) of the recording layer 1 varies on the focused position, resulting in execution of data recording. During the data reading process, when the recording/reading beam L₁ is focused on the recorded position, a fluorescent light (constituting the light response of the medium) is emitted in accordance with the condition on the recorded position. The fluorescent light is then guided through a lens 15 to the detector 16, and, based on the detected signal, the recorded data can be reproduced. To form the beam spot of the recording/reading beam L₁ precisely on a desired recording plane, the optical system 14 forming the projection optical path of said beam is configured as a spherical aberration-corrected optical system. In addition, the focusing optical system 14 is designed such as not to cause any spherical aberration higher than a predetermined tolerance. As for the reference beam L₂, small spherical aberration is generally allowed.

Focusing of the recording/reading beam is controlled by detection of at least one of the following: reflection of the reference beam from the reference layer 2 and fluorescent response from the recording layer. More specifically, during recording, focusing of the recording/reading beam is controlled by detection of reflection of the reference beam, and during reading, focusing of the recording/reading beam is controlled by detection of fluorescent response from the recording layer and preferably also reflection of the reference beam. It should be noted that when speaking about detection of the fluorescent response for the purposes of controlling the focusing, this fluorescent response may be from the recording layer or from the non-recording layer in accordance with the selected change in fluorescent property of these layers.

1. An optical information carrier comprising:
at least one active layer for recording/reading data in/from as a result of one- or multi-photon interaction; and
at least one reference layer structure associated with said at least one active layer, the reference layer structure comprising at least one dielectric material and being different from that of the active layer in its optical properties with respect to one- or multi-photon interaction, detection of light returned from the reference layer structure allowing to control a process of focusing an optical beam onto an addressed recording plane in the active layer during at least one of the recording and reading processes.

2. The information carrier of claim 1, wherein said reference layer structure is partially reflective for a reference beam of a certain wavelength.

3. The information carrier of claim 2, wherein the reflectivity of the reference layer structure at the reference beam wavelength is at least about 1%.

4. The information carrier of claim 1, wherein said reference layer structure is substantially optically transparent for an optical beam used in the recording and reading processes and for the emitted response light.

5. The information carrier of claim 4, wherein, through interaction with the reference layer structure, optical losses of said optical beam used in the recording and reading processes and of response light of the active layer during the reading process are less than 30%.

6. The information carrier of claim 4, wherein, through interaction with the reference layer structure, optical losses of said optical beam used in the recording and reading processes and of response light of the active layer during the reading process are less than 10%.

7. The information carrier of claim 4, wherein, through interaction with the reference layer structure, optical losses of said optical beam used in the recording and reading processes and of response light of the active layer during the reading process are less than 3%.

8. The information carrier of claim 4, wherein, through interaction with the reference layer structure, optical losses of said optical beam used in the recording and reading processes and of response light of the active layer during the reading process are less than 1%.

9. The information carrier of claim 4, wherein, through interaction with the reference layer structure, optical losses of said optical beam used in the recording and reading processes and of response light of the active layer during the reading process are less than 0.1%.

10. The information carrier of claim 2, wherein the at least one reference layer structure is configured to define a plurality of interfaces at different distances from an adjacent active layer.

11. The information carrier of claim 10, wherein the reference layer structure has a pattern in the form of an internal surface relief.

12. The information carrier of claim 11, wherein the pattern is in the form of spaced-apart pits.

13. The information carrier of claim 11, wherein the reference layer structure defines at least three said interfaces.

14. The information carrier of claim 11, wherein the reference layer structure is configured to define four said interfaces.

15. The information carrier of claim 11, wherein the pits are arranged in a spaced-apart relationship along an array of spaced-apart tracks.

16. The information carrier of claim 15, wherein said array of spaced-apart tracks is defined by segments of a continuous spiral path.

17. The information carrier of claim 15, wherein said array of spaced-apart tracks is defined by concentric rings.

18. The information carrier of claim 15, wherein the pits are arranged in a spaced-apart relationship within grooves provided in said spaced-apart tracks.

19. The information carrier of claim 15, wherein one or more parameters of said surface-relief pattern is/are selected to enable tracking of scanning of the recording planes in the active layer during at least one of the recording and reading processes.

20. The information carrier of claim 15, wherein one or more parameters of said surface-relief pattern is/are selected to enhance reflective response of the reference layer structure to the reference beam.

21. The information carrier of claim 19, wherein said one or more parameters include at least one of the following: the distance between the tracks, the degree of overlap between the pits in different tracks along a radial direction, and the pit dimensions.

22. The information carrier of claim 21, wherein the pits are arranged such that there is no overlap between the pit(s) of sectors in adjacent tracks.

23. The information carrier of claim 22, wherein the sector is a single-pit unit.

24. The information carrier of claim 22, wherein the sector is a multiple-pit unit, the pits within the unit being spaced from one another a smaller distance than the space between the sectors in the track.

25. The information carrier according to claim 1, comprising a support layer interfacing the reference layer structure at its side opposite to that interfacing with the active layer,

26. The information carrier according to claim 25, wherein a refractive index of the support layer is substantially equal to a refractive index of said active layer.

27. The information carrier of claim 2, wherein the reference layer structure comprises a first dielectric layer coated with a second dielectric film, the composite two layers having said at least partial reflectivity to the reference beam.

28. The information carrier of claim 2, wherein the reference layer structure has a refractive index different from a refractive index of the adjacent active layer and/or an adjacent support layer, such that the refractive index difference creates said partial reflectivity to the reference beam at an interface between the respective adjacent layer and the reference layer structure.

29. An optical information carrier comprising:
at least one active layer for recording/reading data in/from as a result of one- or multi-photon interaction; and
at least one reference layer structure associated with said at least one active layer, the reference layer structure comprising a dielectric material and having optical properties with respect to one- or multi-photon interaction different from that of the active layer, the reference layer structure being configured to define at least three interfaces in an optical path of light propagation there through and being at least partially reflective for a reference beam of a predetermined wavelength range.

30. An optical information carrier, comprising:
at least one active layer for recording/reading data therein as a result of one- or multi-photon interaction; and
at least one reference layer structure interfacing with the active layer, the reference layer being at least partially reflective for a reference beam wavelength range, an interface between the active layer and the reference layer structure having a pattern of spaced-apart pits arranged in multiple tracks structure, an arrangement of said pits in the interface plane being selected to enable controlling at least one of the reading and recording processes by detecting reflection of the reference beam from said interface.

31. An optical data carrier, comprising:
at least one active layer for recording/reading data therein as a result of one- or multi-photon interaction; and
at least one reference layer structure associated with said at least one active layer, the reference layer structure carrying spatial-positional information, said reference layer structure comprising at least one dielectric material layer having different optical properties with respect to one- or multi-photon interaction used in the recording and reading processes as compared to its adjacent layer at one or both sides thereof, said reference layer structure defining a patterned surface interfacing with the adjacent layer, the reference layer structure being configured to be substantially optically transparent for the recording and reading light and for light response of the active layer during the reading process and to be at least partially reflective for a reference beam, to thereby enable, by said patterned surface, control of the reference beam scanning of a reference track in the reference layer structure by detecting reflections of the reference beam from the reference layer structure, thereby controlling coupled optical beam scan in the active layer.

32. An optical information carrier comprising:
at least one active layer for recording/reading data in/from as a result of one- or multi-photon interaction; and
at least one reference layer structure associated with said at least one active layer, the reference layer structure comprising a dielectric material and having optical properties with respect to one- or multi-photon interaction different from that of the active layer, the reference layer structure being configured to have at least two of the following features:
a) it is substantially transparent to light used in recording and reading processes;
b) it is at least partially reflective to a reference beam wavelength range;
c) it is substantially transparent to light response of the active layer as a result from said interaction;
d) it has a pattern comprising tracking information detectable by at least one optical beam.

33. The information carrier of claim 1, wherein said active layer comprises an active material that changes its optical property as a result of one- or multi-photon interaction, said active material comprising an acrylic copolymer.

34. The information carrier of claim 33, wherein said acrylic copolymer comprises diarylalkylene units and methylmethacrylate units.

35. The information carrier of claim 33, wherein said acrylic copolymer comprises blocks of active random acrylic copolymers separated by short flexible spacers.

36. The information carrier of claim 33, wherein said active layer is applied by a coating or printing onto a substrate of a polymer solution containing active monomer units.

37. The information carrier of claim 1, wherein a difference in refractive indices of the reference layer structure and the adjacent active layer at reference beam wavelength is greater than 0.2.

38. The information carrier of claim 1, wherein said dielectric material used in the reference layer structure is selected from the following: metal chalcogenide: TiO2, ZrO2, Ta2O5, HfO2, Y2O3, ZnS, Nb2O5; complex metal oxide: LaTiO3, ITO, PZT; metal carbide: SiC; metal nitride: Si3N4, and AlN, and mixtures thereof.
